(19) United States
(12) Patent Application Publication
(10) Pub. No.: US 2026/0307572 A1
(43) Pub. Date: Oct. 8, 2026

(54) RAMP APPARATUS FOR VEHICLE

(71) Applicants: Hyundai Motor Company, Seoul (KR); Kia Corporation, Seoul (KR)

(72) Inventors: Kyu Hoon Cho, Hwaseong-si (KR); Gook Hyun Jeon, Hwaseong-si (KR); Dae Hun Song, Hwaseong-si (KR); Jae Seung Lee, Hwaseong-si (KR); Hyuk Ho Kwon, Hwaseong-si (KR); Jae Hyun Seo, Incheon (KR); Woo Sik Yoon, Incheon (KR); Sung Won Hong, Incheon (KR); Min Su Kim, Seoul (KR)

(21) Appl. No.: 19/272,483

(22) Filed: Jul. 17, 2025

(30) Foreign Application Priority Data
Apr. 2, 2025 (KR) 10-2025-0042670

(51) Int. Cl. B60P 1/43; A61G 3/06; B60K 1/04

(52) U.S. Cl. CPC B60P 1/431; A61G 3/061; B60K 1/04; B60K 2001/0438

(57) ABSTRACT

In an embodiment a ramp apparatus includes a housing having an opening on one side, a platform having driving rollers and being movable between a storage position within the housing and a deployed position outside the housing, a pair of guide rails extending in a movement direction of the platform within the housing and configured to guide a movement of the driving roller, a drive portion installed within the housing and configured to generate a driving force to move the platform and a driving cable interposed between the drive portion and the platform and configured to transmit the driving force of the drive portion to the platform, wherein the driving cable is partially accommodated in the guide rail and is movable along the guide rail.

### CROSS-REFERENCE TO RELATED APPLICATIONS

This application claims benefit of priority to Korean Patent Application No. 10-2025-0042670 filed on Apr. 2, 2025 in the Korean Intellectual Property Office, the disclosure of which is incorporated herein by reference in its entirety.

### TECHNICAL FIELD

The present disclosure relates to a ramp apparatus for a vehicle in which a platform is deployed from a vehicle body to the ground as well as being retracted into the vehicle body.

### BACKGROUND

A bus or a wheelchair-specific vehicle for the disabled may include a ramp apparatus that assists boarding of a wheelchair. The ramp apparatus is equipped with a platform stored on the floor of the vehicle body, and the platform is deployed automatically or manually by the user from the vehicle body to the ground, so that the deployed platform is configured to incline at a certain angle with respect to the ground.

On the other hand, vehicles that use a motor as a driving source, such as hybrid vehicles or electric vehicles, use a high-voltage battery or the like as an energy source for driving the motor, and a battery module including multiple battery cells is mounted on the vehicle body at the bottom of the vehicle. In this case, if a ramp apparatus for a wheelchair is mounted on the vehicle, the ramp apparatus interferes with the layout of the battery module because it is mainly mounted on the bottom of the vehicle, and cannot be applied.

To solve this issue, if the ramp apparatus is disposed on the floor panel of the vehicle body, the step height increases, making it inconvenient for passengers to get on and off. In addition, since the height of the ramp apparatus from the ground may be relatively high, it may be difficult for the inclination of the platform to satisfy the inclination of a regulation (for example, 7.1°), and there may be a disadvantage, in that the step difference between the platform and the interior floor may be excessive.

### SUMMARY

Embodiments provide a ramp apparatus for a vehicle, which may maintain and/or improve the convenience of boarding and disembarking passengers by making the inclination of a platform satisfy the inclination of a regulation without increasing a step height.

Further embodiments provide a ramp apparatus for a vehicle in which a height of the ramp apparatus itself is significantly reduced and a step difference between the platform and the interior floor may be eliminated while implementing the deploying and rising of the platform.

According to an embodiment of the present disclosure, a ramp apparatus includes a housing having an opening in one side; a platform having a driving roller and being movable between a storage position within the housing and a deployed position outside of the housing; a pair of guide rails extending in a movement direction of the platform within the housing and guiding a movement of the driving roller; a drive portion installed within the housing and generating driving force to move the platform; and a driving cable interposed between the drive portion and the platform and transmitting the driving force of the drive portion to the platform. The driving cable is partially accommodated in the guide rail and moves along the guide rail.

The housing may include at least one roller member installed on a lower inner surface around the opening and supporting a movement of the platform.

The platform may include a step panel; a moving frame which has the driving rollers on both sides and to which one end of the driving cable is connected; and a hinge panel respectively connected to the step panel and the moving frame by a hinge between the step panel and the moving frame.

The hinge panel may include at least one cam-shaped portion provided in a position corresponding to the roller member, on a lower surface.

The cam-shaped portion may have a curved surface to which a cycloid curve is applied.

A height of the cam-shaped portion may have the same dimension as a diameter of the roller member.

As the cam-shaped portion rotates, the hinge panel may rotate toward the moving frame and one end of the step panel may be raised, and the hinge panel may be rotated more than 90 degrees from a horizontal plane.

The housing may include an inclined plate installed on an upper outer surface, around the opening and supporting the hinge panel rotated.

The guide rail may include a first guide groove accommodating the driving roller and guiding the driving roller, and a second guide groove accommodating the driving cable and guiding the driving cable. One side groove wall of the first guide groove may be cut so that a rotation axis of the driving roller is capable of passing therethrough.

The driving roller may have a groove provided in a circumferential direction, having a cross-sectional shape of one of V, U, and W shapes. On upper and lower inner surfaces of the first guide groove, protrusions having a cross-sectional shape corresponding to the groove of the driving roller may be provided, respectively.

The guide rail may be formed of an extruded material.

The drive portion may have a motor and a gear. The driving cable may have gear teeth formed on an outer peripheral surface thereof, engage with the gear, and move by driving force of the motor.

According to an embodiment of the present disclosure, a ramp apparatus includes a housing having an opening in one side; a platform having a driving roller and being moveable between a storage position within the housing and a deployed position outside of the housing; and a protective bar installed on the platform and deployable in a height direction according to a movement of the platform.

The platform may include a step panel; a moving frame having the driving rollers on both sides; and a hinge panel respectively connected to the step panel and the moving frame by a hinge between the step panel and the moving frame.

The housing may include at least one roller member installed on a lower inner surface around the opening and supporting a movement of the platform. The hinge panel may include at least one cam-shaped portion formed in a position corresponding to the roller member, on a lower surface.

The protective bar may include a bar member; a driving link having one end rotatably hinged to the hinge panel; a connecting link having one end rotatably hinged to the bar member, the other end rotatably hinged to the other end of the driving link, and rotatably connected to the step panel via a rotating pin; and at least one sub-link having one end rotatably hinged to the bar member, and the other end rotatably hinged to the step panel.

When the hinge panel is rotated toward the moving frame according to rotation of the cam-shaped portion, the driving link may push the other end of the connecting link. The connecting link may be rotated around the rotating pin, so that one end of the connecting link is lifted. The bar member may be lifted from an upper surface of the step panel together with the sub-link.

The ramp apparatus may further include a drive portion installed in the housing and generating driving force moving the platform; and a driving cable interposed between the drive portion and the platform, and transmitting the driving force of the drive portion to the platform.

The drive portion may have a motor and a gear. The driving cable may have one end connected to the platform, have gear teeth formed on an outer surface, engage with the gear, and move by driving force of the motor.

The ramp apparatus may further include a plurality of reinforcing rails coupled to an upper surface of the housing. The reinforcing rails may have ends protruding from the housing on both sides of the housing, and the ends on both sides may be coupled to cross members of a vehicle body.

### BRIEF DESCRIPTION OF THE DRAWINGS

The above and other embodiments, features, and advantages of the present disclosure will be more clearly understood from the following detailed description, taken in conjunction with the accompanying drawings, in which:

FIG. 1 is a perspective view illustrating a main part of a vehicle to which a ramp apparatus according to an embodiment is applied;

FIG. 2 is a perspective view of a ramp apparatus according to an embodiment from above;

FIG. 3 is a perspective view of the ramp apparatus illustrated in FIG. 2 from below;

FIG. 4 is a perspective view of FIG. 2 with an upper case separated;

FIG. 5 is an exploded perspective view of a ramp apparatus according to an embodiment;

FIG. 6 and FIG. 7 are perspective views illustrating a platform;

FIG. 8 is a perspective view of the platform illustrated in FIG. 6 from below;

FIG. 9 is an enlarged view illustrating a portion of the platform in the deployed position;

FIG. 10 is an enlarged cross-sectional view of a guide rail;

FIG. 11 is a bottom view illustrating a drive portion and a driving cable;

FIG. 12 is a drawing illustrating the operation process of a ramp apparatus according to an embodiment in sequence; and

FIG. 13 is an operational state diagram of a ramp apparatus according to an embodiment.

### DETAILED DESCRIPTION OF ILLUSTRATIVE EMBODIMENTS

Hereinafter, the present disclosure will be described in detail through example drawings. When adding reference numerals to components of respective drawings, it should be noted that the same components are given the same numerals as much as possible even if they are illustrated in different drawings.

In this specification, a vehicle refers to various vehicles that move a transported object such as a person, an animal, or an object from a starting point to a destination. Such vehicles are not limited to vehicles that run on roads or tracks.

In this specification, for the convenience of explanation, the present disclosure is described using a vehicle having a motor that receives power from a battery, such as a hybrid vehicle or an electric vehicle, as an example, but the present disclosure is not necessarily limited thereto.

In this specification, the terms first, second, etc. may be used to describe various components, but these components are not limited in terms of order, size, location, or importance by the terms first, second, etc., and are named only for the purpose of distinguishing one component from another.

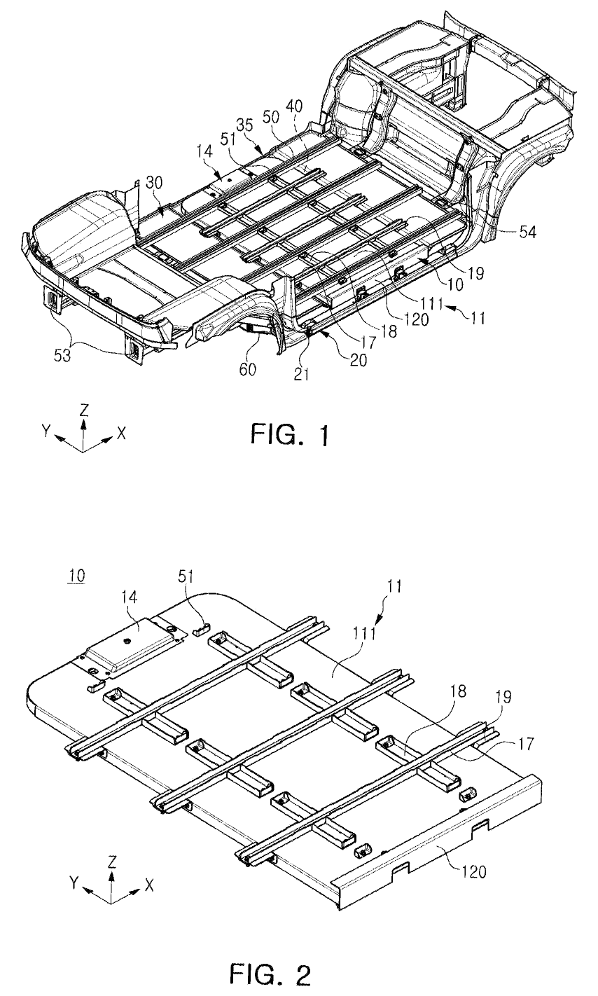

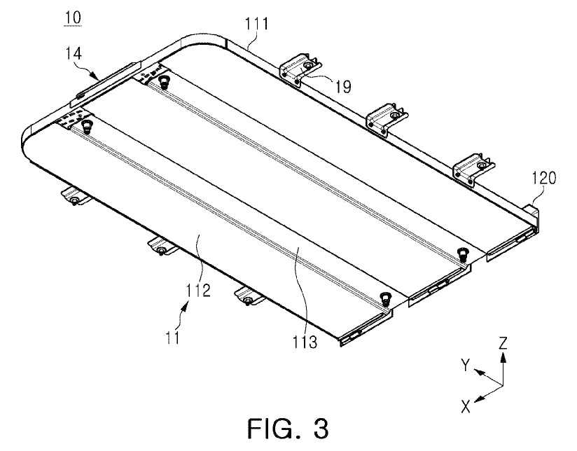

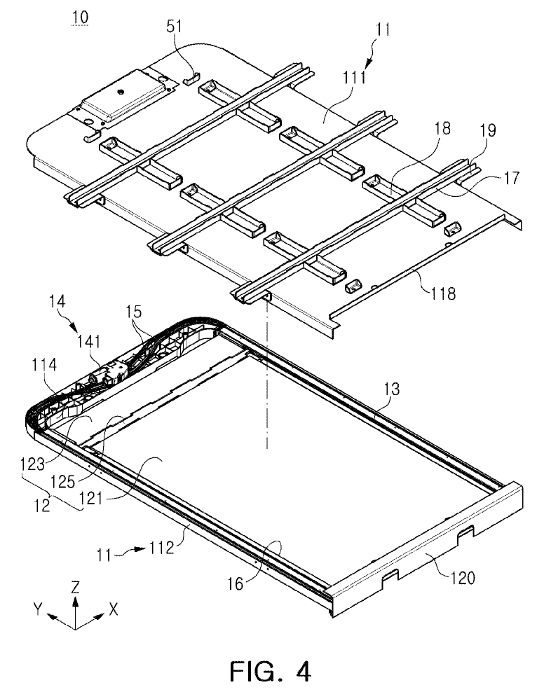

FIG. 1 is a perspective view illustrating a main part of a vehicle to which a ramp apparatus according to an embodiment is applied. FIG. 2 is a perspective view of a ramp apparatus according to an embodiment from above, FIG. 3 is a perspective view of the ramp apparatus illustrated in FIG. 2 from below, and FIG. 4 is a perspective view of FIG. 2 with an upper case separated.

First, the vehicle may include a vehicle body, and the vehicle body may be manufactured in various shapes and sizes. The skeletal structure of the vehicle body may be composed of a pair of side sills 20 extending in the longitudinal direction (X) of the vehicle and forming a side surface of the vehicle body, and a plurality of cross members 40 extending in the width direction (Y) of the vehicle and coupled to both side sills.

A pair of side sills 20 may be disposed on the left and right sides of the lower portion of the vehicle body, and the pair of side sills may be spaced apart from each other along the width direction (Y) of the vehicle. These side sills may perform the function of protecting the passenger space in the event of a side collision of the vehicle while forming the appearance of the vehicle side.

At least one of the pair of side sills 20 may have a concave portion 21 in which the upper surface is formed lower than the surroundings in the middle portion. The concave portion may be located below a door (not illustrated) of the vehicle. The space created by the concave portion may be used for a platform 12 of the ramp apparatus 10 to enter and move.

A plurality of cross members 40 may be connected to the side sill at intervals from the front end to the rear end of the vehicle body. When the vehicle is hit from the side, the collision load transmitted to the cross members may be transmitted to the side sill 20 mechanically connected to the cross members and distributed along the side sill in the longitudinal direction (X) of the vehicle.

Optionally, a battery module 60 may be disposed in the middle of the vehicle in the longitudinal direction (X) and the lower part thereof in the height direction (Z). To this end, a battery space in which a battery module is mounted may be provided in the vehicle body.

A floor panel 30 may be installed above the battery space. In detail, the battery module 60 may be mounted on a pair of side sills 20 to be disposed under the floor panel.

The floor panel 30 may be disposed between a pair of side sills 20. The floor panel may partition a passenger space in which passengers board.

In detail, the floor panel 30 may be joined to the side sills by welding, for example, the left and right edges of the floor panel to respective side sills 20. In addition, the floor panel may be disposed on the cross members 40 and joined to respective cross members by bolting, or the like.

The floor panel 30 may include a recess portion 35 formed concavely downward. The recess portion may have an approximately U-shaped cross-section. By means of this recess portion, the floor panel may be formed stepwise along the longitudinal direction of the vehicle.

Optionally, the vehicle may further include at least one reinforcing cross member (not illustrated) which is disposed on the floor panel 30, extends in the width direction (Y) of the vehicle, and has both ends coupled to the side sills 20. By providing the reinforcing cross member in this way, the rigidity of the side sills, whose cross-sectional size in the vertical direction is reduced due to the concave portion 21, may be reinforced.

A ramp apparatus 10 according to an embodiment may be stably installed in the recess portion 35 of the floor panel 30 and fixedly coupled to the floor panel. In the ramp apparatus, when the driving force of the drive portion 14 is transmitted to the platform 12, the platform may be pulled out from the housing 11 and disposed in a deployed position with one end touching the ground.

Since the ramp apparatus 10 is positioned within the recess portion 35 and is positioned lower than before, the inclination of the platform 12 may satisfy the inclination of the regulation without increasing the step height. Accordingly, the ramp apparatus according to an embodiment may maintain and/or improve the convenience of getting on and off the passenger.

The housing 11 may accommodate components of the ramp apparatus, such as the platform 12, drive portion 14, and the like. To this end, the housing may be equipped with an upper case 111 and a lower case 112.

The housing 11 may include a plurality of reinforcing rails 17 coupled to the upper surface of the upper case 111, and a plurality of connecting rails 18 coupled to the upper surface of the upper case, on both sides of each reinforcing rail.

To couple the reinforcing rail 17 to the vehicle body, for example, the cross member 40, a mounting bracket 19 having a cross-sectional shape bent in an inverted L shape and having bolt holes formed therein may be welded to both side walls of the upper case 111. In addition, bolt holes may be formed in both ends of the reinforcing rail in the longitudinal direction (for example, the longitudinal direction (X) of the vehicle).

The plurality of reinforcing rails 17 connect the load path between the front side member 53 and the rear side member 54 that are disconnected due to the recess portion 35 of the floor panel 30 and the ramp apparatus 10, thereby dispersing and transmitting the collision load and reducing the deformation of the vehicle body when the vehicle collides.

Optionally, above the housing 11 of the ramp apparatus 10, for example, on the upper surface of the upper case 111, a plurality of seat rails 50 for installing the vehicle seat may be disposed to extend across the housing of the ramp apparatus along the longitudinal direction (X) of the vehicle, along with a plurality of reinforcing rails 17.

When the ramp apparatus 10 is settled in the recess portion 35 of the floor panel 30, the plurality of seat rails 50 may be respectively positioned in the space between the connecting rails 18 on the upper surface of the upper case 111 or positioned parallel to the reinforcing rail 17 with the connecting rails therebetween. Each seat rail may be coupled to the upper surface of the upper case by bolting via the connecting bracket 51.

The plurality of seat rails 50 together with the plurality of reinforcing rails 17 and the plurality of connecting rails 18 are disposed in a grid shape on the upper surface of the upper case 111 forming the housing 11 of the ramp apparatus 10. Accordingly, the ramp apparatus may be firmly fixed to the floor panel 30, and the durability and rigidity of the vehicle body, which are disadvantaged due to the downward arrangement of the ramp apparatus, are supplemented, so that the collision load is distributed during a side collision, and deformation of the vehicle body may be minimized.

In addition, the housing 11 may include at least one channel portion 113 formed on the lower surface of the lower case 112 to accommodate a reinforcing cross member.

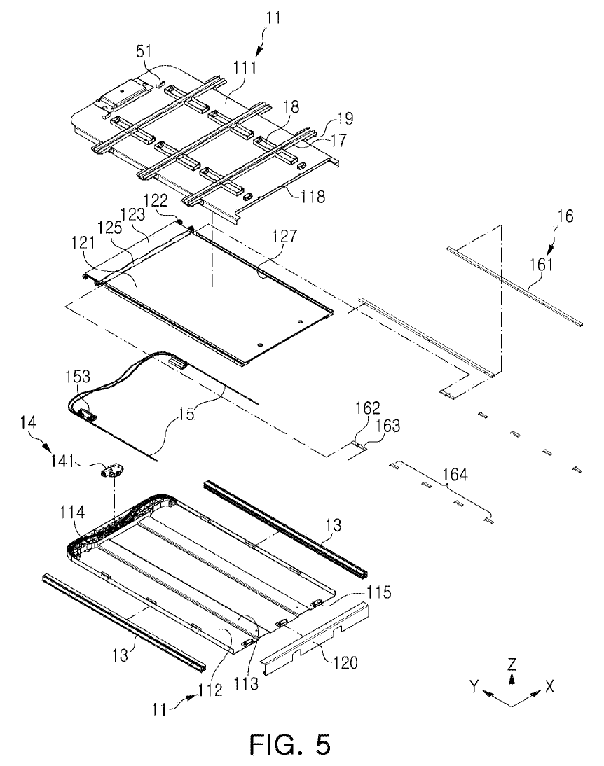

FIG. 5 is an exploded perspective view of a ramp apparatus according to an embodiment.

A ramp apparatus 10 according to an embodiment may include a housing 11; a platform 12; a guide rail 13; a drive portion 14; and a driving cable 15.

As described above, the housing 11 may include an upper case 111 and a lower case 112.

The upper case 111 may include an upper surface and a pair of side walls extending downward from both side edges of the upper surface. The upper case may be formed to cover the lower case 112.

A mounting bracket 19 having a cross-sectional shape bent into an inverted L shape and having bolt holes formed therein may be welded to both side walls of the upper case 111.

The lower case 112 may include a lower surface and a pair of side walls extending upward from both side edges of the lower surface. The lower case may movably support a platform 12 and a driving cable 15, and a guide rail 13, a drive portion 14 and the like may be fixedly installed therein.

The side walls of the upper case 111 and the side walls of the lower case 112 may be bolted to a mounting bracket 19 together with the guide rail 13. As a result, the upper case and the lower case may form a housing 11, and the housing may have an internal space partitioned by the upper case and the lower case.

The housing 11 may have an opening on one side between the side walls and may be opened toward the exterior of the vehicle. As a result, the platform 12 may enter and exit the housing through the opening.

A driving frame 114 may be disposed on the other side between the side walls of the housing 11, and the opposite side of the opening may be closed by the driving frame. The driving frame may be fixedly installed to at least the lower case 112, and a drive portion 14 may be mounted on the driving frame.

Optionally, at least one roller member 115 may be installed adjacent to the opening of the housing 11, on the lower surface of the lower case 112, for example, on the inner surface, to support the movement of the platform 12.

By means of this roller member 115, the platform may smoothly slide within the housing, and accordingly, the platform may smoothly enter and exit the housing through the opening.

In addition, the roller member 115 may be linked with the cam-shaped portion 126 described later to rotate the hinge panel 125 of the platform 12 and raise one end of the step panel 121.

A gate 119 may be provided in the opening of the housing 11 through which the platform 12 enters and exits. For example, a hinge portion 116 may be provided on both side walls of the lower case 112, or on both lateral sides on the lower surface, and the gate may be rotatably connected to each hinge portion via the hinge axis. In addition, a torsion spring (not illustrated) may be interposed between the hinge portion and the hinge axis. As a result, the gate may open or automatically close the opening depending on the entry and exit of the platform.

In addition, optionally, the gate 119 may further include a contact roller 117 disposed at an edge opposite to the hinge axis of the gate to reduce friction by enabling rolling contact with the surface of the platform 12 when the platform is withdrawn.

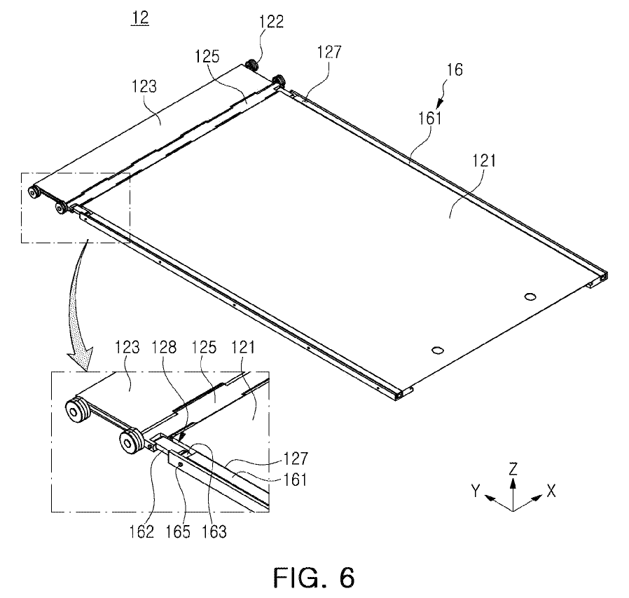

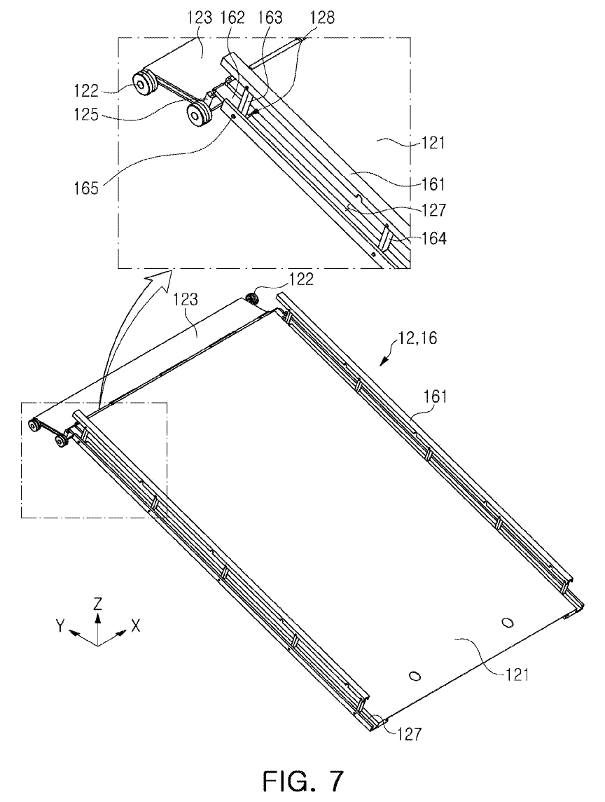

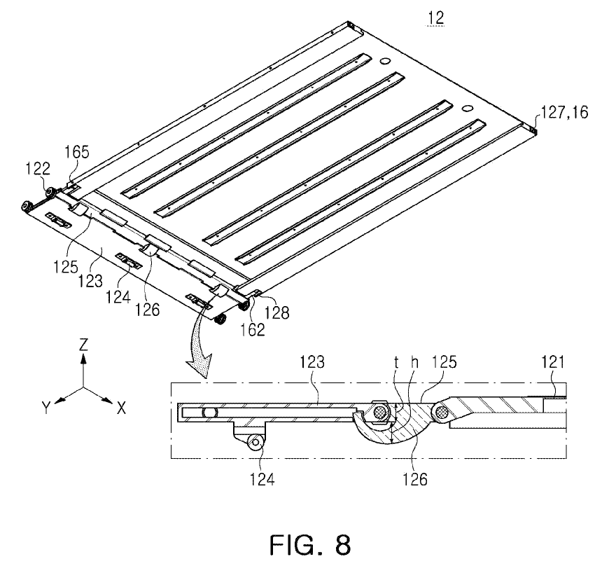

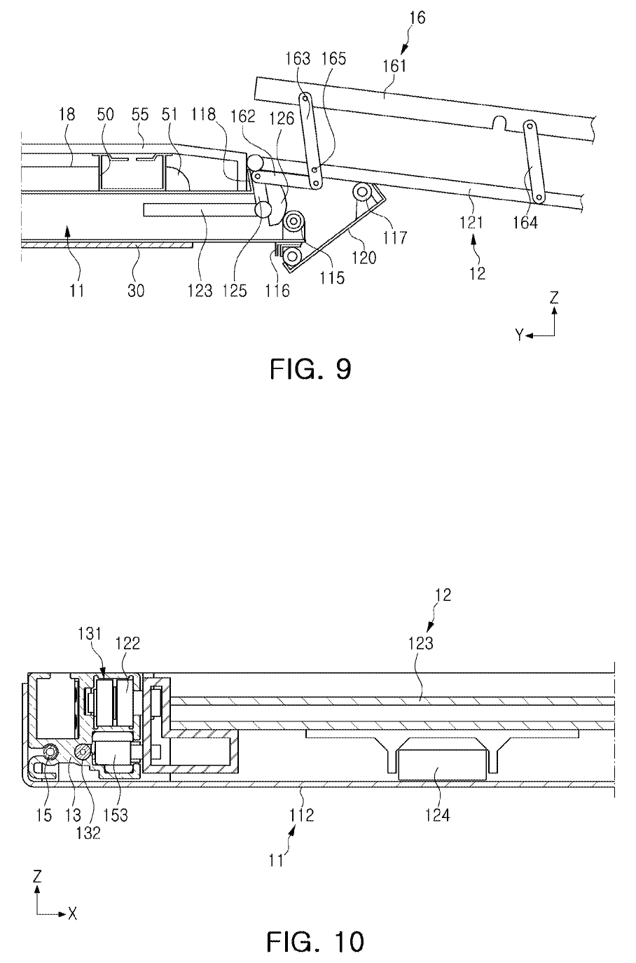

FIGS. 6 and 7 are perspective views illustrating the platform, and FIG. 8 is a perspective view of the platform illustrated in FIG. 6 as viewed from below. FIG. 9 is an enlarged view illustrating a portion of the platform in the deployed position.

The platform 12 may be configured to be movable between a storage position in which it is stored in the internal space of the housing 11, and a deployed position in which it is extended outward from the housing.

For example, the platform 12 may include a step panel 121, a moving frame 123 having a driving roller 122 on both sides, respectively, and a hinge panel 125 interposed between the step panel and the moving frame and connected to the step panel and the moving frame by a hinge, respectively.

The step panel 121 is a flat-shaped member, and one side of the step panel 121 may be supported by the moving frame 123 via the hinge panel 125 in the internal space of the housing 11, and the other side thereof may be supported by the roller member 115.

One end of the step panel 121 may be connected to the hinge panel 125 by a hinge. Accordingly, the step panel may rotate downward by gravity as it is pulled out from the housing 11. When the platform 12 is pulled out, the other end of the step panel may push and open the gate 119.

In the deployed position, the other end of the step panel 121 may be supported by contacting the ground, and one end of the step panel may be completely pulled out from the housing 11 while being connected to the hinge panel 125, and may be disposed at a position higher than the housing.

Accordingly, one end of the step panel 121 is connected to the interior floor 55 of the vehicle, and passengers, wheelchairs, strollers, and the like may safely move on the step panel.

In addition, the step panel 121 may be rotated back from an inclined state to a generally horizontal state with the roller member 115 as a support point as it is introduced into the housing 11, and the platform 12 may smoothly enter and exit the housing while maintaining a horizontal state by the moving frame 123 and the roller member.

The moving frame 123 is a member having a substantially flat shape, and may be provided with a driving roller 122 on both sides respectively. In addition, one end of the moving frame may be connected to a hinge panel 125 by a hinge.

The driving roller 122 may be guided in the movement thereof by the guide rail 13 within the housing 11. As a driving roller, a roller having a groove formed in the circumferential direction with a cross-sectional shape of one of V, U, and W shapes may be employed. As a result, the moving frame 123 and the platform 12 are restricted from moving left and right and may only move in the withdrawal or introduction direction.

In addition, the moving frame 123 may include at least one sub-roller 124 mounted on the lower surface. The sub-roller may freely rotate according to the movement of the moving frame, and may movably support the moving frame within the lower case 112 of the housing 11.

In this way, the moving frame 123 may smoothly slide within the housing 11 by the driving roller 122 and the sub-roller 124. The moving frame may be positioned within the housing without completely coming out of the housing when the platform 12 is withdrawn.

The hinge panel 125 may be a flat-shaped member, and one side thereof is connected to a step panel 121 by a hinge, and the other side thereof is connected to a moving frame 123 by a hinge.

The hinge panel 125 may include at least one cam-shaped portion 126 formed in a position corresponding to the roller member 115 of the housing 11 in the longitudinal direction of the hinge panel 125 (for example, the longitudinal direction (X) of the vehicle), on the lower surface thereof.

The cam-shaped portion 126 may have a curved surface to which a cycloid curve is applied, for example. The height (h) of the cam-shaped portion, for example, the height of the curved surface obtained by subtracting the thickness (t) of the hinge panel from the total length of height direction (Z) of the hinge panel 125, may have a dimension equal to the diameter of the roller member 115.

When the platform 12 is withdrawn and the cam-shaped portion 126 of the hinge panel 125 meets the roller member 115, the cam-shaped portion may rotate around the hinge axis connected to the hinge panel and the moving frame 123 as much as the stroke of the step panel 121 deployed, while maintaining contact between the curved surface and the roller member. According to the rotation of the cam-shaped portion, the hinge panel rotates toward the moving frame, and thus, one end of the step panel connected to the hinge panel may be raised.

For example, the hinge panel 125 may be rotated at least 100 degrees, exceeding 90 degrees from the horizontal plane, in proportion to the deploying stroke of the step panel 121, and one end of the step panel may be raised by about 40 to 50 mm from the position when it is in a horizontal state.

Accordingly, since one end of the step panel 121 completely pulled out from the housing 11 may be connected to the upper surface of the interior floor 55, the step difference between the platform 12 and the interior floor may be eliminated by simply applying the cam-shaped portion 126 without increasing the height of the ramp apparatus 10, particularly the housing.

Optionally, an inclined plate 118 for supporting a rotated hinge panel 125 may be installed on the upper surface of the upper case 111, for example, on the outer surface, adjacently to the opening of the housing 11. The inclined plate and the hinge panel may together perform the role of supporting the raised step panel 121.

The ramp apparatus 10 according to an embodiment may further include a protective bar 16 that is installed on the platform 12 and may be deployed in the height direction according to the movement of the platform.

To install the protective bar 16, the step panel 121 of the platform 12 may be formed with a receiving groove 127 that is concave toward the upper surface of the step panel and extends along the longitudinal direction of the step panel, adjacent to the left and right edges of the step panel when both ends of the longitudinal direction (for example, the width direction (Y) of the vehicle) of the step panel, parallel to the moving direction of the platform, is referred to as the front and rear. The receiving groove may be open at both longitudinal ends, and a through-hole 128 may be formed in the bottom of the receiving groove, at the end adjacent to the hinge panel 125.

The protective bar 16 may include a bar member 161, a driving link 162, a connecting link 163, and at least one sub-link 164.

The bar member 161 may be formed as a member having a cross-sectional shape of an approximately inverted U. This bar member may be inserted into a receiving groove 127 while accommodating a connecting link 163 and at least one sub-link 164 therein. The bar member may have a length shorter than the longitudinal length of the step panel 121.

The driving link 162 may have one end rotatably hinged to the hinge panel 125 and the other end rotatably hinged to the connecting link 163. The driving link may push or pull the connecting link according to the rotation of the hinge panel.

The connecting link 163 may have one end rotatably hinged to the bar member 161 and the other end rotatably hinged to the driving link 162. The connecting link 163 may be rotatably connected to both side walls of the through-hole via a rotating pin 165 to pass through the through-hole 128 or be partially accommodated in the receiving groove 127. Accordingly, when force is applied from the driving link to the other end of the connecting link, the connecting link may be rotated to pass through the through-hole or be accommodated in the receiving groove.

At least one sub-link 164 may have one end rotatably hinged to the bar member 161 and the other end rotatably hinged to both side walls of the receiving groove 127 within the receiving groove 127.

In the protective bar 16 configured in this manner, when the hinge panel 125 rotates and the other end of the step panel 121 is lowered by its own weight, the hinge panel and the step panel fold, and as the distance between the hinge point of the driving link 162 on the hinge panel and the hinge point (for example, the rotating pin 165) of the connecting link 163 in the through-hole 128 on the step panel becomes closer, the driving link may push the hinge point with the other end of the connecting link.

In this way, by applying force from the driving link 162 to the other end of the connecting link 163, the connecting link is rotated around the rotating pin 165 in the through-hole 128, and one end of the connecting link may be lifted from the receiving groove 127 of the step panel 121. As one end of the connecting link is lifted, the bar member 161 may be lifted from the upper surface of the step panel together with the sub-link 164 by a predetermined height.

According to an embodiment, the ramp apparatus 10 includes a protective bar 16 that may be deployed to a height that satisfies the regulatory standard (for example, 51 mm or more), thereby obtaining the effect of preventing the wheelchair from falling when the protective bar is fully deployed, without increasing the height of the ramp apparatus.

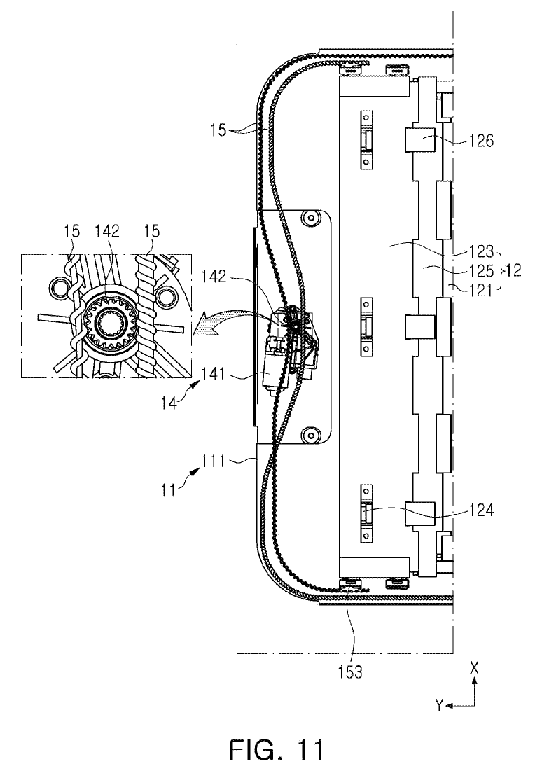

FIG. 10 is an enlarged cross-sectional view of the guide rail, and FIG. 11 is a bottom view illustrating the drive portion and the driving cable.

Referring to FIGS. 4, 5, 10, and 11 together, the guide rails 13 may be provided in pairs. These guide rails may be installed to extend along the length of the step panel 121, adjacent to the left and right edges of the step panel 121 inside the housing 11, to guide the movement of the platform 12, in detail, the moving frame 123. The guide rails may be formed by extrusion using, for example, aluminum or an aluminum alloy as a material.

The guide rail 13 may include a first guide groove 131 accommodating a driving roller 122 and guiding the movement of the driving roller, and a second guide groove 132 accommodating a driving cable 15 and guiding the movement of the driving cable.

In this case, one-side groove wall of the first guide groove 131 may be cut so that the rotation axis of the driving roller 122 may pass therethrough, and a protrusion having a cross-sectional shape of one of V, U, and W shapes may be formed on the upper and lower inner surfaces of the first guide groove, respectively.

In this way, since the function of guiding the movement of the driving roller 122 and the function of guiding the movement of the driving cable 15 are integrated into the guide rail 13, it may be helpful in configuring the ramp apparatus 10 slimly without increasing the height of the housing 11.

Optionally, the guide rail 13 may be bolted to the mounting bracket 19 together with the side wall of the upper case 111 and the side wall of the lower case 112 that constitute the housing 11 of the ramp apparatus 10, but is not limited thereto.

These guide rails 13 may not only guide the movement of the platform 12, but also reinforce the rigidity of the ramp apparatus 10 and absorb the collision load by being deformed together with the housing when the vehicle collides.

The driving force that allows the platform 12 to be guided by the guide rails 13 to enter and exit the housing 11 may be generated from a drive portion 14 including a motor 141 and a gear 142, such as a helical gear. A motor capable of forward and reverse rotation may be employed as the motor, and the rotation direction, rotation speed, and the like may be determined according to a control signal from a control unit (not illustrated), for example. This drive portion may be mounted on a driving frame 114 that closes the other side of the housing.

At least one driving cable 15 has helical gear teeth formed on the outer peripheral surface thereof and may move forward or backward by the driving force of the motor 141 while engaging with the gear 142 of the drive portion 14. The driving cable is flexible and have bending characteristics.

One end of the driving cable 15 may be fixedly connected to the moving frame 123 via, for example, a connecting block 153 that is double-injected, but is not limited thereto, and may be connected to the moving frame without a connecting block.

The other end of the driving cable 15 is inserted into one of the pair of second guide grooves 132 of the guide rail 13 and may move along the second guide groove.

The driving cable 15 of which one end is connected to the moving frame 123 on one of the left or right side of the step panel 121 may be extended so that the other end is inserted into the second guide groove 132 of the guide rail 13 adjacent to the other side of the step panel by passing through the driving frame 114 and the drive portion 14.

For example, the driving cables 15 may be provided in pairs and may mesh with each other with the gear 142 of a single drive portion 14 interposed therebetween, on both sides of the gear 142. When the gear rotates in one direction by the motor 141, the paired driving cables may move in opposite directions.

In this case, one of the paired driving cables 15 may be inserted into one of the pair of second guide grooves 132 of one guide rail 13 and moved, and the other driving cable may be inserted into the other second guide groove of the guide rail and moved.

As the driving cable 15 is guided and moved by the guide rail 13, the moving frame 123 connected to one end of the driving cable may be moved within the housing 11.

For example, in FIG. 11, when the gear 142 is rotated counterclockwise by the motor 141, the right driving cable 15 moves upward and the left driving cable 15 moves downward, so that the moving frame 123 moves toward the opening of the housing 11, and the step panel 121 may be pulled out of the housing.

Conversely, when the gear 142 rotates clockwise, the driving cables 15 move in the reverse direction, and accordingly, the moving frame 123 moves toward the driving frame 114 of the housing 11, so that the step panel 121 may be introduced into the housing.

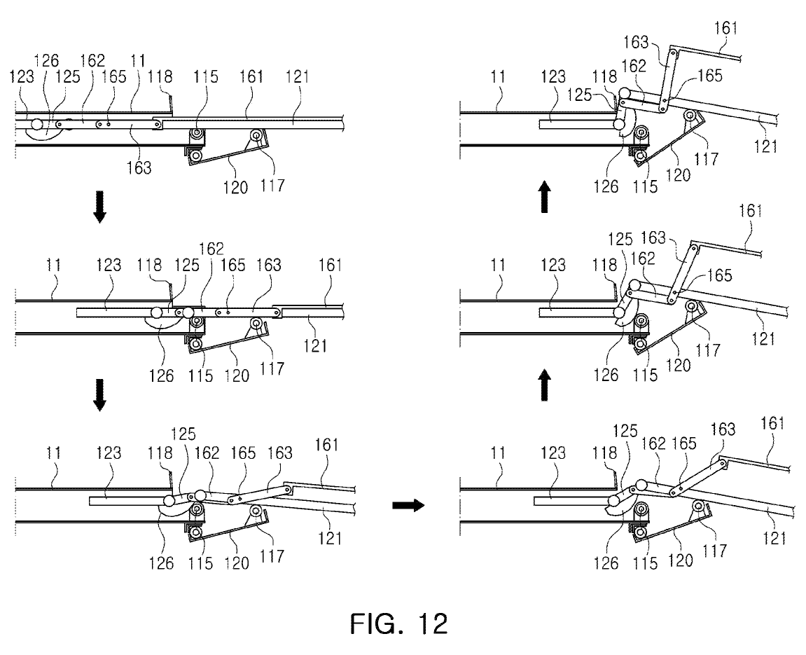

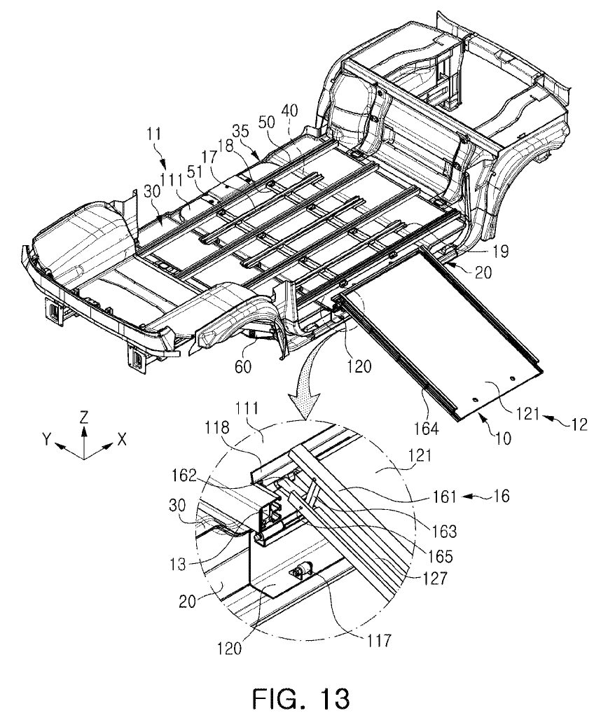

FIG. 12 is a drawing sequentially illustrating the operation process of the ramp apparatus according to an embodiment, and FIG. 13 is a diagram illustrating the operation state of the ramp apparatus according to an embodiment.

The process of the platform 12 being pulled out of the housing 11 from the storage position within the housing 11 and reaching the deployed position is described.

When the motor 141 of the drive portion 14 rotates under the control of the control unit, and thus the gear 142 rotates in one direction, the paired driving cables 15 move in opposite directions, thereby transmitting driving force to the moving frame 123 so that the moving frame moves toward the opening of the housing 11.

The driving roller 122 of the moving frame 123 may move along the guide rail 13, and the moving frame may push the hinge panel 125 hinged to one end thereof and the step panel 121 hinged to the hinge panel. At this time, the step panel may be supported by at least one roller member 115 applied to the inner surface of the lower case 112 and simultaneously therewith, may slide with minimal friction.

The gate 119 closes the opening of the housing 11 by a torsion spring, and as the step panel 121 moves, rotates by the force pushing the gate, so that the opening may be opened. The contact roller 117 of the gate may come into rolling contact with the lower surface of the step panel to significantly reduce friction.

As the step panel 121 of the platform 12 is pulled out of the housing 11, the step panel 121 gradually sags due to its own weight. When the hinge axis to which the step panel and the hinge panel 125 are connected reaches the roller member 115 of the lower case 112, the other end of the step panel may be supported by contacting the ground.

Then, the cam-shaped portion 126 of the hinge panel 125 and the roller member 115 begin to contact, and while the contact between the curved surface having the cycloid curve of the cam-shaped portion 126 and the roller member is maintained, the cam-shaped portion and the hinge panel may rotate around the hinge axis connected to the hinge panel and the moving frame 123 at the same speed as the deploying stroke of the step panel 121.

The hinge panel 125 is rotated toward the moving frame 123, and thus, one end of the step panel 121 hinged to the hinge panel may be raised.

When the hinge panel 125 is rotated and the other end of the step panel 121 is lowered by its own weight, the hinge panel and the step panel are folded, and as the distance between the hinge point of the driving link 162 in the hinge panel and the hinge point (for example, the rotating pin 165) of the connecting link 163 in the through-hole 128 in the step panel becomes closer, the driving link may push the hinge point with the other end of the connecting link.

Thereby, the connecting link 163 may be rotated around the rotating pin 165 in the through-hole 128, so that one end of the connecting link may be lifted from the receiving groove 127 of the step panel 121. As one end of the connecting link is lifted, the bar member 161 is lifted from the upper surface of the step panel together with the sub-link 164 by a predetermined height, so that the protective bar 16 may be automatically deployed in the height direction.

When the hinge panel 125 is completely rotated by the cam-shaped portion 126 and one end of the step panel 121 is raised to the maximum and then slightly lowered, the inclined plate 118 of the upper case 111 may support the hinge panel. In addition, the inclined plate and the hinge panel may support the raised step panel together. In this way, even if a load such as the weight of a wheelchair or the like is applied to the step panel, the hinge panel may be prevented from rotating further.

As set forth above, according to embodiments, by disposing a ramp apparatus downward together with a floor panel and making the ramp apparatus slim, the inclination of a platform may satisfy the inclination of a regulation without increasing the step height, and there is an effect of maintaining and/or improving the convenience of getting on and off the passenger.

In addition, according to embodiments, the effect of eliminating a step difference between a platform and an interior floor while implementing the platform's deploying and rising is obtained.

While example embodiments have been illustrated and described above, it will be apparent to those skilled in the art that modifications and variations could be made without departing from the scope of the present disclosure as defined by the appended claims.

What is claimed is:

1. A ramp apparatus comprising:
a housing having an opening on one side;
a platform having driving rollers and being movable between a storage position within the housing and a deployed position outside the housing;
a pair of guide rails extending in a movement direction of the platform within the housing and configured to guide a movement of the driving roller;
a drive portion installed within the housing and configured to generate a driving force to move the platform; and
a driving cable interposed between the drive portion and the platform and configured to transmit the driving force of the drive portion to the platform,
wherein the driving cable is partially accommodated in the guide rail and is movable along the guide rail.

2. The ramp apparatus of claim 1, wherein the housing includes at least one roller member installed on a lower inner surface at the opening, wherein the roller member is configured to support a movement of the platform.

3. The ramp apparatus of claim 1, wherein the platform comprises:
a step panel,
a moving frame including the driving rollers on both sides and to which one end of the driving cable is connected, and
a hinge panel respectively connected to the step panel and the moving frame by a hinge between the step panel and the moving frame.

4. The ramp apparatus of claim 3, wherein the hinge panel includes at least one cam-shaped portion on a lower surface and positioned to correspond to roller member.

5. The ramp apparatus of claim 4, wherein the cam-shaped portion has a curved surface comprising a cycloid curve.

6. The ramp apparatus of claim 4, wherein a height of the cam-shaped portion is the same as a diameter of the roller member.

7. The ramp apparatus of claim 4, wherein the hinge panel is configured to rotate toward the moving frame and to raise one end of the step panel in response to the cam-shaped portion rolling along the roller member, the hinge panel being rotatable more than 90 degrees from a horizontal plane.

8. The ramp apparatus of claim 3, wherein the housing includes an inclined plate located on an upper outer surface at the opening and supporting the hinge panel.

9. The ramp apparatus of claim 1, wherein the guide rail comprises:
a first guide groove accommodating the driving roller and guiding the driving roller, and
a second guide groove accommodating the driving cable and guiding the driving cable, and
wherein one side groove wall of the first guide groove is cut so that a rotation axis of the driving roller is capable of passing therethrough.

10. The ramp apparatus of claim 9,
wherein the driving roller has a groove in a circumferential direction,
wherein the groove has a cross-sectional shape of one of V, U, or W shapes, and
wherein the first guide groove have protrusions on upper and lower inner surfaces,
wherein the protrusions have a cross-sectional shape corresponding to the groove of the driving roller, respectively.

11. The ramp apparatus of claim 1, wherein the guide rail comprises an extruded material.

12. The ramp apparatus of claim 1,
wherein the drive portion has a motor and a gear,
wherein the driving cable has gear teeth formed on an outer peripheral surface,
wherein the gear teeth are engageable with the gear, and
wherein the driving cable is movable by driving force of the motor.

13. A ramp apparatus comprising:
a housing having an opening on one side;
a platform having driving rollers and being moveable between a storage position within the housing and a deployed position outside of the housing; and
a protective bar installed on the platform and deployable in a height direction according to a movement of the platform.

14. The ramp apparatus of claim 13, wherein the platform comprises:
a step panel,
a moving frame having the driving rollers on both sides, and
a hinge panel respectively connected to the step panel and the moving frame by a hinge between the step panel and the moving frame.

15. The ramp apparatus of claim 14,
wherein the housing includes at least one roller member installed on a lower inner surface at the opening and supporting the movement of the platform, and
wherein the hinge panel includes on a lower surface at least one cam-shaped portion positioned to correspond to the roller member.

16. The ramp apparatus of claim 15, wherein the protective bar comprises:
a bar member,
a driving link having one end rotatably hinged to the hinge panel,
a connecting link having one end rotatably hinged to the bar member, another end rotatably hinged to another end of the driving link and rotatably connected to the step panel via a rotating pin, and
at least one sub-link having one end rotatably hinged to the bar member and another end rotatably hinged to the step panel.

17. The ramp apparatus of claim 16,
wherein the driving link is configured to push another end of the connecting link in response to the hinge panel being rotated toward the moving frame according to a rotation of the cam-shaped portion,
wherein the connecting link is configured to rotate around the rotating pin so that one end of the connecting link is lifted, and
wherein the bar member is configured to lift from an upper surface of the step panel together with the sub-link.

18. The ramp apparatus of claim 13, further comprising:
a drive portion installed in the housing and configured to generate a driving force moving the platform; and
a driving cable interposed between the drive portion and the platform and configured to transmit the driving force of the drive portion to the platform.

19. The ramp apparatus of claim 18,
wherein the drive portion has a motor and a gear, and
wherein the driving cable has one end connected to the platform,
wherein the driving cable has gear teeth formed on an outer surface,
wherein the gear teeth are engageable with the gear and
the driving cable is movable by the driving force of the motor.

20. The ramp apparatus of claim 1, further comprising a plurality of reinforcing rails coupled to an upper surface of the housing,
wherein the reinforcing rails have ends protruding from the housing on both sides of the housing, and
wherein the ends on both sides are coupled to cross members of a vehicle body.
